(19) United States
(12) Patent Application Publication
(10) Pub. No.: US 2005/0160264 A1
(43) Pub. Date: Jul. 21, 2005

(54) Trusted authentication credential exchange methods and apparatuses

(76) Inventors: Reid Kuhn, Seattle, WA (US); Patrick J. Masse, Woodinville, WA (US); Alexander B. Coyne, Redmond, WA (US)

Correspondence Address: LEE & HAYES PLLC, 421 W RIVERSIDE AVENUE SUITE 500, SPOKANE, WA, 99201, US

(21) Appl. No.: 10/762,012

(22) Filed: Jan. 21, 2004

(51) Int. Cl. H04L 9/00

(52) U.S. Cl. 713/168

(57) ABSTRACT

Methods and apparatuses are provided for use in authenticating credential information and allowing such credential information to be exchanged over non-secure channels in a safe and protected manner.

### TECHNICAL FIELD

The present invention relates generally to computers and like devices, and more particularly to improved methods and apparatuses for use in authenticating credential information.

### BACKGROUND

Computing networks and environments vary in size and purpose. Most computer networks and computing systems require potential users to present some sort of proof that they are allowed to access the computing resources. Typically, users are required to enter a qualifying user name and password prior to accessing the system. Some network security schemes require potential users to present a portable token or other like mechanism to help verify that they are authorized to access certain resources. For example, smartcards are becoming more popular for authenticating users.

Other trends have lead to the use of biometric information. Here, biometric information is gathered using various devices/sensors and the resulting credential information is logically compared to previously stored credential information for the user.

Authentication technologies such as biometrics have certain inherent qualities that make them both desirable and difficult to implement, however. One problem is that the gathered credential information that is provided for authentication is public in nature (i.e. fingerprints, irises, faces, etc. . . . ) as opposed to secret passwords, etc. Indeed, biometric data for a given user may be left in hundreds of places every day. An additional difficulty is that, unlike the current secure forms of authentication today (e.g., passwords and smartcards) where the credentials themselves are used as (or to create) key blobs which are consistent across multiple sessions, biometric credential data is not consistent across multiple sessions. This means that to authenticate an entity, the gathered credential information will likely need to be transmitted to wherever the authentication process is to take place; in the case of network user authentication, this means that the credential may need to be transmitted in its entirety to an authentication server.

Consequently, there is a need for methods and apparatuses for use in authenticating credential information and that allow such credential information to be exchanged over non-secure channels in a safe and protected manner.

### SUMMARY

The above stated needs and others are met, for example, by a method that includes establishing authentication information. The authentication information includes time information associated with authenticating logic. The method further includes establishing credential information with first logic, and outputting an authentication request including the authentication information and the credential information. The authentication request has been cryptographically modified for protection.

The authentication request may then be provided to second logic and passed on to applicable authenticating logic. The authentication request may be cryptographically modified by first logic or by the second logic. In certain implementations, the second logic may also include certificate or other like information in the authentication requests that is passed on to the authenticating logic.

The authenticating logic may be configured to receive the authentication request, and at least validate the authentication information, and authenticate the credential information. The authenticating logic may then output an authentication response including, for example, authentication approval information and corresponding cryptography information.

As part of certain methods, the first logic may be configured to access at least a portion of the authentication response to retrieve the corresponding cryptography information, which is then provided to the second logic for use in decrypting the encrypted authentication response.

In other implementations, the second logic may be configured to access at least a portion of the authentication response to directly retrieve the corresponding cryptography information without using the first logic.

In certain implementations, the method also includes having the authenticating logic establish a temporary key, and using the temporary key to encrypt authentication approval information. A copy of the temporary key may also be encrypted using a public key. In certain implementations, the temporary key includes a symmetric key.

The first logic may be substantially provided in a first device that includes a credential gathering mechanism that is configurable to establish the credential information. The credential gathering mechanism may be configurable to establish biometric information. The second logic may be provided at least partially in a second device, and the authenticating logic may be provided at least partially in a third device. The second device may include, for example, at least one computer or like device that is operatively configured as a client, and the third device may include at least one computer or like device that is operatively configured as a server.

The authenticating logic may be configured to validate the authentication information based on at least nonce data and timestamp data within the authentication information.

### BRIEF DESCRIPTION OF THE DRAWINGS

A more complete understanding of the various methods and apparatuses of the present invention may be had by reference to the following detailed description when taken in conjunction with the accompanying drawings wherein:

FIG. 1 is a block diagram that depicts a exemplary device in the form of a computer system.

FIG. 2 is a block diagram depicting an exemplary system having three devices in which credential information from a first device is passed through a second device to a third device that is capable of authenticating the credential information and returning an access token, for example, to the second device.

FIG. 3 is a flow diagram depicting certain exemplary acts associated with a method for use in a system, such as, for example, as depicted in FIG. 2.

FIG. 4 is a flow diagram depicting certain further exemplary acts associated with a method, such as, for example, as depicted in FIG. 3.

FIG. 5 is another flow diagram depicting certain further exemplary acts associated with a method, such as, for example, as depicted in FIG. 3.

FIG. 6 is still another flow diagram depicting certain further exemplary acts associated with a method, such as, for example, as depicted in FIG. 3.

FIG. 7 is yet another flow diagram depicting certain further exemplary acts associated with a method, such as, for example, as depicted in FIG. 3.

### DETAILED DESCRIPTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

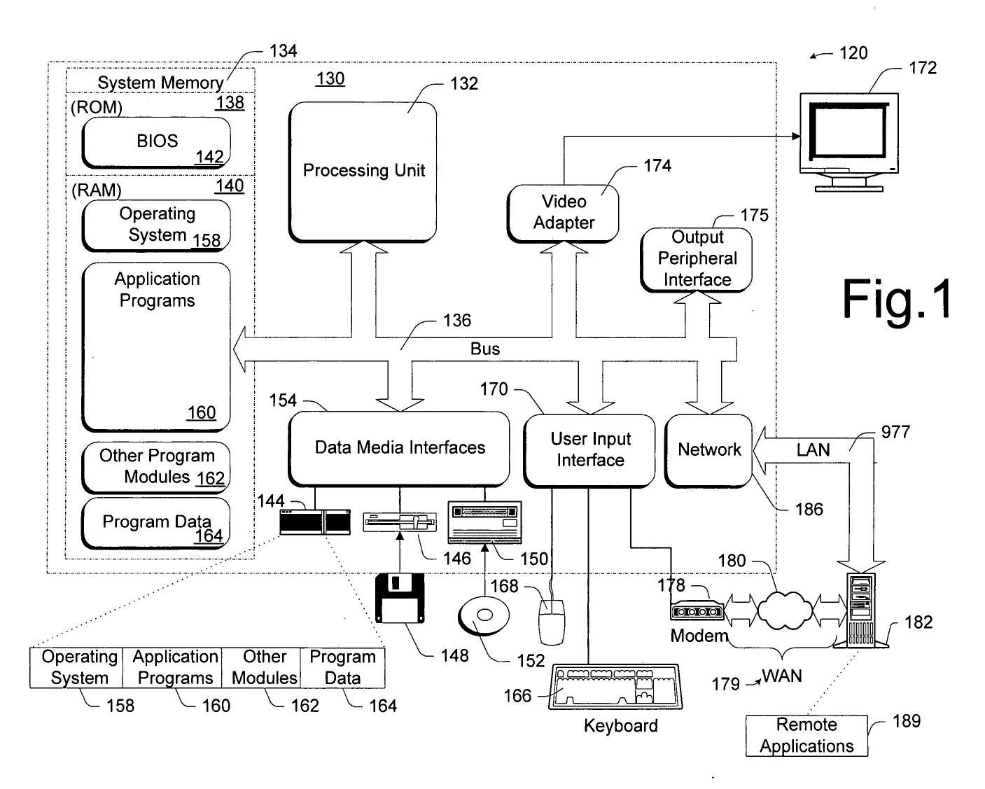

FIG. 1 illustrates an example of a suitable computing environment 120 with which the subsequently described methods and apparatuses may be implemented.

Exemplary computing environment 120 is only one example of a suitable computing environment and is not intended to suggest any limitation as to the scope of use or functionality of the improved methods and apparatuses described herein. Neither should computing environment 120 be interpreted as having any dependency or requirement relating to any one or combination of components illustrated in computing environment 120.

The improved methods and apparatuses herein are operational with numerous other general purpose or special purpose computing system environments or configurations. Examples of well known computing systems, environments, and/or configurations that may be suitable include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

As shown in FIG. 1, computing environment 120 includes a general-purpose computing device in the form of a computer 130. The components of computer 130 may include one or more processors or processing units 132, a system memory 134, and a bus 136 that couples various system components including system memory 134 to processor 132.

Bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

Computer 130 typically includes a variety of computer readable media. Such media may be any available media that is accessible by computer 130, and it includes both volatile and non-volatile media, removable and non-removable media.

In FIG. 1, system memory 134 includes computer readable media in the form of volatile memory, such as random access memory (RAM) 140, and/or non-volatile memory, such as read only memory (ROM) 138. A basic input/output system (BIOS) 142, containing the basic routines that help to transfer information between elements within computer 130, such as during start-up, is stored in ROM 138. RAM 140 typically contains data and/or program modules that are immediately accessible to and/or presently being operated on by processor 132.

Computer 130 may further include other removable/non-removable, volatile/non-volatile computer storage media. For example, FIG. 1 illustrates a hard disk drive 144 for reading from and writing to a non-removable, non-volatile magnetic media (not shown and typically called a “hard drive”), a magnetic disk drive 146 for reading from and writing to a removable, non-volatile magnetic disk 148 (e.g., a “floppy disk”), and an optical disk drive 150 for reading from or writing to a removable, non-volatile optical disk 152 such as a CD-ROM, CD-R, CD-RW, DVD-ROM, DVD-RAM or other optical media. Hard disk drive 144, magnetic disk drive 146 and optical disk drive 150 are each connected to bus 136 by one or more interfaces 154.

The drives and associated computer-readable media provide nonvolatile storage of computer readable instructions, data structures, program modules, and other data for computer 130. Although the exemplary environment described herein employs a hard disk, a removable magnetic disk 148 and a removable optical disk 152, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk, magnetic disk 148, optical disk 152, ROM 138, or RAM 140, including, e.g., an operating system 158, one or more application programs 160, other program modules 162, and program data 164.

The improved methods and apparatuses described herein may be implemented within operating system 158, one or more application programs 160, other program modules 162, and/or program data 164.

A user may provide commands and information into computer 130 through input devices such as keyboard 166 and pointing device 168 (such as a “mouse”). Other input devices (not shown) may include a microphone, joystick, game pad, satellite dish, serial port, scanner, camera, etc. These and other input devices are connected to the processing unit 132 through a user input interface 170 that is coupled to bus 136, but may be connected by other interface and bus structures, such as a parallel port, game port, or a universal serial bus (USB).

A monitor 172 or other type of display device is also connected to bus 136 via an interface, such as a video adapter 174. In addition to monitor 172, personal computers typically include other peripheral output devices (not shown), such as speakers and printers, which may be connected through output peripheral interface 175.

Computer 130 may operate in a networked environment using logical connections to one or more remote computers, such as a remote computer 182. Remote computer 182 may include many or all of the elements and features described herein relative to computer 130.

Logical connections shown in FIG. 1 are a local area network (LAN) 177 and a general wide area network (WAN) 179. Such networking environments are commonplace in offices, enterprise-wide computer networks, intranets, and the Internet.

When used in a LAN networking environment, computer 130 is connected to LAN 177 via network interface or adapter 186. When used in a WAN networking environment, the computer typically includes a modem 178 or other means for establishing communications over WAN 179. Modem 178, which may be internal or external, may be connected to system bus 136 via the user input interface 170 or other appropriate mechanism.

Depicted in FIG. 1, is a specific implementation of a WAN via the Internet. Here, computer 130 employs modem 178 to establish communications with at least one remote computer 182 via the Internet 180.

In a networked environment, program modules depicted relative to computer 130, or portions thereof, may be stored in a remote memory storage device. Thus, e.g., as depicted in FIG. 1, remote application programs 189 may reside on a memory device of remote computer 182. It will be appreciated that the network connections shown and described are exemplary and other means of establishing a communications link between the computers may be used.

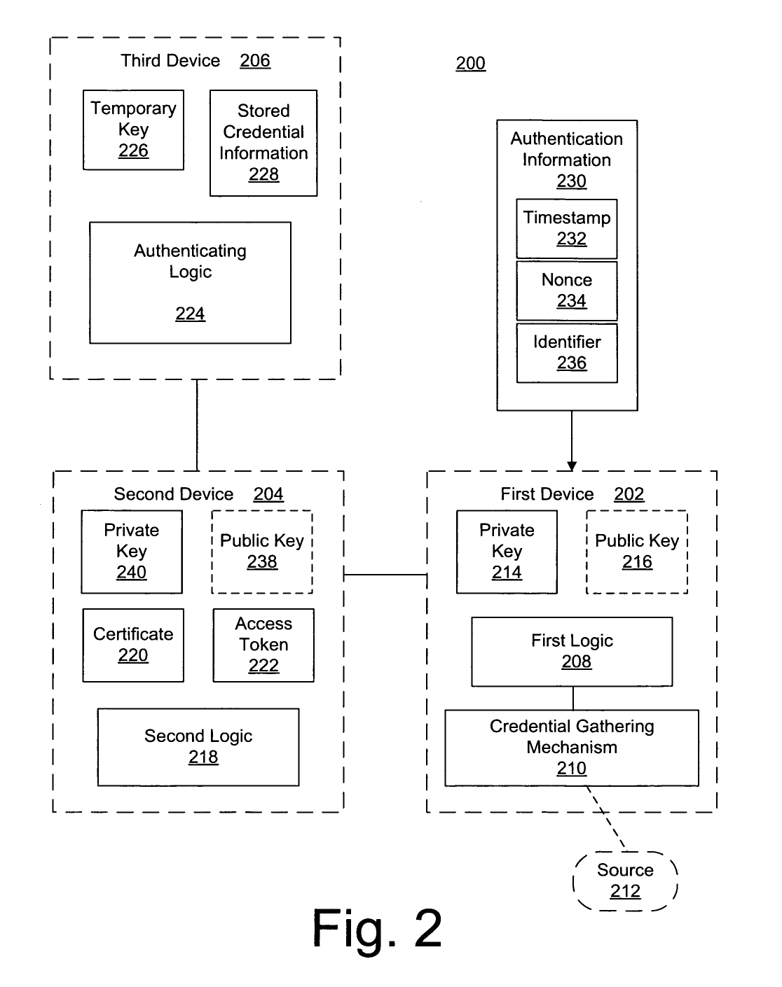

Attention is now drawn to FIG. 2, which is a block diagram depicting an exemplary system 200 having three representative devices and in which credential information from a first device is passed through a second device to a third device that is capable of authenticating the credential information and returning an access token, for example, to the second device in accordance with a protocol as defined in the exemplary methods and apparatuses described and shown herein.

System 200 includes first device 202, second device 204 and third device 206. At a minimum, first device 202 is operatively coupled to second device 204, and second device 204 is operatively coupled to third device 206. In other implementations, additional connectively may be provided as well as additional requisite or otherwise supporting interconnecting resources.

In this example, first device 202 includes first logic 208 and credential 11 gathering mechanism 210. It is noted that the term “logic” as used herein is intended to represent a broad range of technical implementation techniques. Such techniques may include, for example, hardware, firmware, software, and/or any combination thereof. Additionally, the term “logic” may respect any additional circuitry, including analog circuitry, etc. that may be used to assist in the performance of one or more functions, processes, and other like tasks in accordance with the methods and apparatuses described and shown herein.

With this in mind, first logic 208 is configured to receive or otherwise access credential information that is gathered/produced by credential gathering mechanism 210. Credential gathering mechanism 210 may include a user input device or other like data/sample gathering tool that is capable of identifying credential information that may be authenticated in some manner by authenticating logic 224 in third device 206. In certain exemplary implementations, for example, credential gathering mechanism 210 gathers biometric information associated with a user (e.g. source 212). In such an implementation, the resulting credential information would include sensed biometric data that can be (at least) logically compared/analyzed by authentication logic 224 to one or more known samples maintained within stored credential information 228. Such data gathering and authentication techniques (and other like techniques) are well known.

Also illustratively shown in first device 202 are private key 214 and related public key 216. In this example, private key 214 and public key 216 are associated with first logic 208 and/or first device 202. In other examples, such key-pairs may also be associated with second logic and/or second device 204. Cryptographic keys such as these and related cryptographic techniques are also well known. The methods and apparatuses provided herein can be adapted for use with a wide variety of such cryptographic techniques.

First logic 208 is configured to provide credential information from credential gathering mechanism to second device 204, and more specifically, second logic 218 therein. In certain exemplary implementations, first logic 208 is configured to simply provide the credential information to second logic 218 without significantly modifying the sample data. In yet other more complex exemplary implementations, first logic 208 is configured to modify the sample data and/or credential information to better secure/protect the data before it is passed from first device 202 to second device 204. These two exemplary implementations are described in more detail below.

In implementations where first logic 208 is configured to modify the credential information before it is provided to second device 204, authentication information 230 is generated and provided to first device 202. Authentication information 230 may be generated, for example, by second logic 218 and/or authenticating logic 224. By way of example, in certain implementations, second logic 218 is configured to request a timestamp 232 and a server nonce (or other like data) from authenticating logic 224. In response to the request, authenticating logic 224 generates and returns timestamp 232 and a server nonce to logic 218. In other implementations, second logic 218 may generate a client nonce, for example. Regardless as to how the resulting nonce 234 is generated (e.g., server or client based), second logic 218 provides authentication information 230 having timestamp 232, nonce 234 and an identifier 236 (associated with the entity being authenticated) to first logic 208.

Having received authentication information 230, first logic 208 then combines authentication information 230 with the credential information from mechanism 210 to form an authentication request. The authentication request is then signed, encrypted or otherwise cryptographically modified by first logic 208 using private key 214. The resulting encrypted authentication request is then provided to second logic 218.

Second logic 218 then passes the encrypted authentication request on to authentication logic 224. In certain implementations, logic 218 may also modify the encrypted authentication request by attaching or otherwise including a certificate 220 to the encrypted authentication request. This “modified” encrypted authentication request is them provided to authentication logic 224. Authentication logic 224 may then, for example, verify the certificate accordingly and/or access public key 216 (or 238) therein.

In other implementations where first logic 208 is not configured to modify the credential information before it is provided to second device 204, authentication information 230 may be generated and provided instead to second device 204 and second logic 218 further configured to combine authentication information 230 with the credential information from first logic 208/mechanism 210 to form an authentication request. The authentication request is then signed, encrypted or otherwise cryptographically modified by second logic 218 using a private key 240 associated with a public key 238, each being further associated with second logic 218 and/or second device 204. The resulting encrypted authentication request (or modified encrypted authentication request) is then provided to authenticating logic 224.

Authenticating logic 224 in third device 206 is configured to receive the encrypted authentication request (or encrypted authentication request with attached certificate) and process it accordingly. For example, authenticating logic 224 can be configured to decrypt the encrypted authentication request using the appropriate public key 216 (or 238), and in doing so verify that the signature is valid. Authenticating logic 224 may then verify that the authentication information 230 is valid, for example, analyzing timestamp 232, nonce 234 and/or identifier 236. Authenticating logic 224 may then authenticate the credential information, for example, by logically comparing the credential information to stored credential information 228. Authentication logic 224 may also check the cache to determine if authentication information 230 is already present in the cache.

If the verification and authentication requirements are satisfied, then authenticating logic 224 generates an authentication response. In certain implementations, authenticating logic 224 may also cache all or part of the authentication request for a period of time to provide a validity window associated with the authentication and/or authentication response.

Exemplary authentication logic 224 creates a temporary key 226 (e.g., a symmetric key) and uses temporary key 226 to sign, encrypt or otherwise cryptographically modify the authentication response. The authentication response may include, for example, an access token or other like information that allows second device 204 to access third device 206 or other related authentication controlled devices. Authentication logic 224 also signs, encrypts or otherwise cryptographically modifies a copy of temporary key 226 using public key 216 (or 238). The resulting encrypted authentication response and encrypted temporary key are then provided to second logic 218.

In those implementations where first logic 208 earlier modified the credential information, then first logic 208 can be used to retrieve the temporary key from the encrypted temporary key received from authentication logic 224. Thus, second logic 218 passes at least the encrypted temporary key to first logic 208, which then uses private key 214 to retrieve temporary key 226. First logic 208 then provides retrieved temporary key 226 to second logic 218.

In other implementations where second logic 218 earlier modified the credential information itself, then second logic 218 can be used to retrieve the temporary key directly from the encrypted temporary key received from authentication logic 224. Thus, second logic 218 uses private key 240 to retrieve temporary key 226.

Once in possession of retrieved temporary key 226, second logic 218 is able to retrieve an access token 222 or other like data from the received encrypted authentication response using temporary key 226.

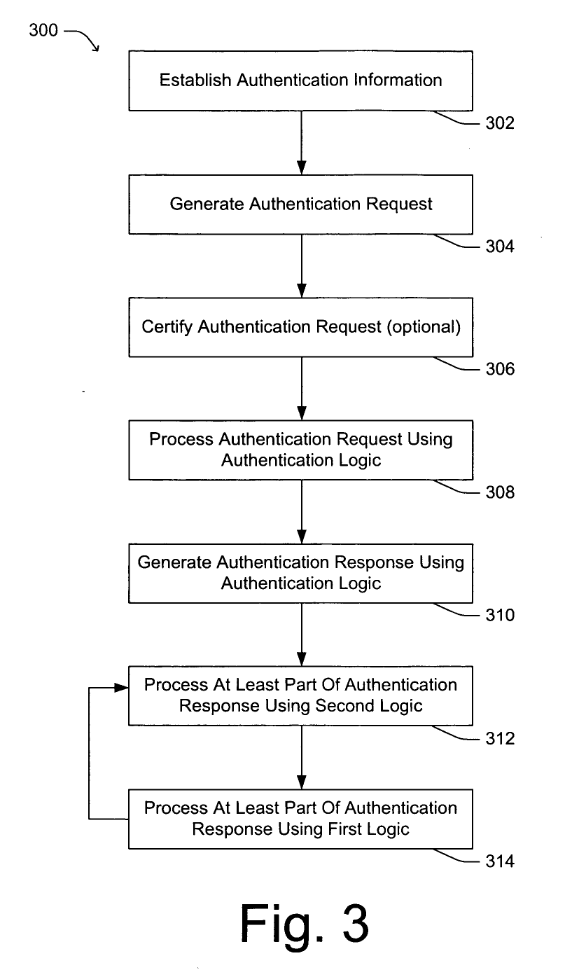

Attention is now drawn to FIG. 3, which is a flow diagram depicting certain exemplary acts associated with a method 300.

In act 302, authentication information 230 is established. For example, in certain implementations second logic 218 and/or authentication logic 224 may be configured to establish authentication information 230. In act 304, an authentication request is generated. First logic 208 and/or second logic 218 may be configured to generate the authentication request.

Act 306 is optional and includes certifying the authentication request generated in act 304. In certain implementations, for example, second logic 218 is configured to certify the authentication request by including certificate 220. In act 308, the authentication request is processed. For example, authentication logic 224 can be configured to verify and/or authenticate information in the authentication request. If the authentication request is authenticated in act 308, then in act 310 a corresponding authentication response is generated, for example, by authentication logic 224 and provided to at least second logic 218.

In act 312, at least a portion of the authentication response is processed by second logic 218. In certain implementations, act 314 is also implemented such that at least a portion of the authentication response is processed by first logic 208. As a result of act 312 (and if used, act 314) access token 222 or other like information is provided to second logic 218 and/or second device 204.

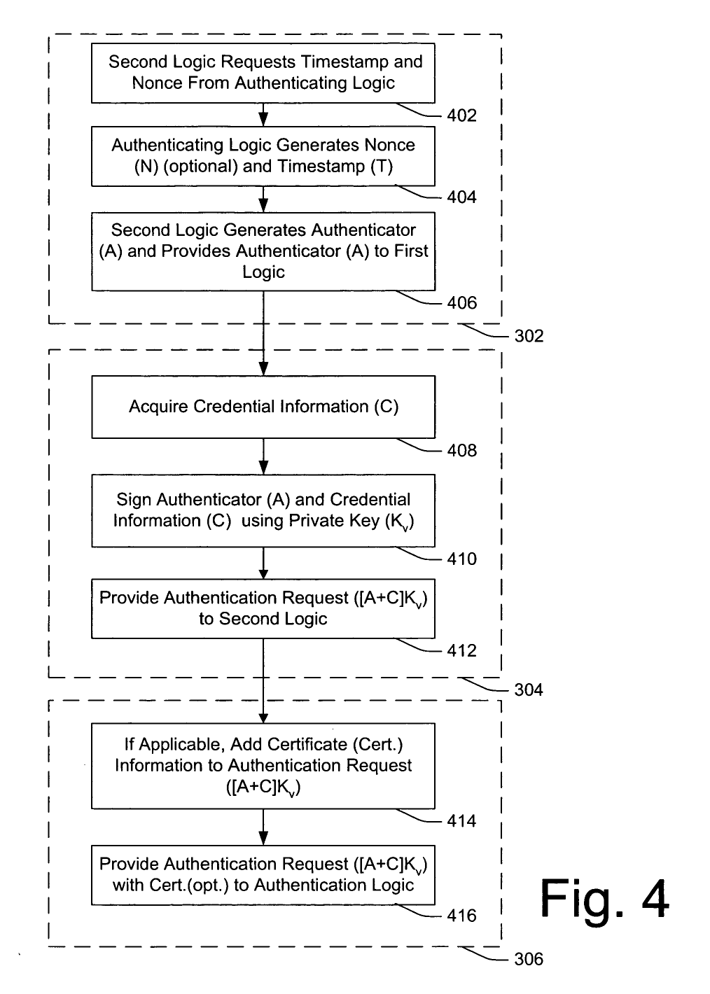

FIG. 4 is a flow diagram depicting certain further exemplary acts associated with acts 302, 304 and 306, in accordance with certain further implementations.

Acts 402, 404 and 406 may be included within act 302. In act 402, second logic 218 requests timestamp 232 and nonce 234 from authenticating logic 224. In act 404, authenticating logic 224 generates a nonce (N) and timestamp (T). In act 406, second logic 218 generates an authenticator (A) and provides authenticator (A) to first logic 208. For example, in certain implementations, authenticator (A) include authentication information 230.

Acts 408, 410 and 412 may be included in act 304. In act 408, credential information (C) is gathered or otherwise acquired. For example, credential gathering mechanism 210 and/or first logic 208 may be used in act 408. In act 410, the authenticator (A) from act 406 is signed using a private key (Kᵥ). In act 412, the resulting authentication request ([A+C]Kᵥ) is provided to second logic 218.

Acts 414 and 416 may be included in act 306. In act 414, if applicable, certificate (Cert.) information is added or otherwise included in the authentication request. In act 416, the authentication request ([A+C]Kᵥ) and (optional) Cert. are provided to authentication logic 224.

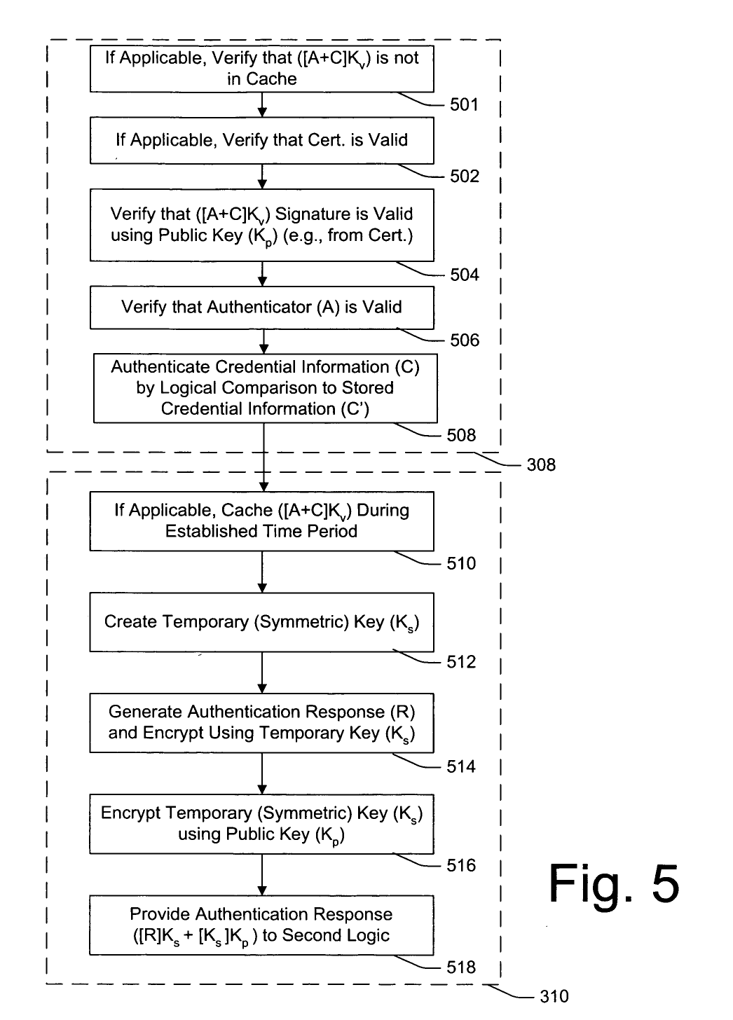

FIG. 5 is another flow diagram depicting certain further exemplary acts that may be included in acts 308 and 310 of FIG. 3.

Acts 501, 502, 504, 506, and 508 may be included in act 308. In act 501 it is determined if ([A+C]Kᵥ) is already in the cache. If a Cert. is included with the authentication request, then in accordance with act 502, authentication logic 224 may verify the certificate. In act 504, authentication logic 224 verifies that the signature for ([A+C]Kᵥ) is valid, for example, using the public key Kₚ associated with private key Kᵥ. The public key Kₚ may be acquired in various conventional ways and/or received in an accompanying certificate. In act 506, the authenticator (A) is verified. In act 508, the credential information (C) is authenticated, for example, using mathematical and/or logical comparison/analysis based on stored or otherwise accessible credential information (C′).

Those skilled in the art will recognize that in other implementations, these and/or other acts may be implemented in differing orders, simultaneously, etc. to that illustrated in the drawings herein. By way of example, in certain implementations, act 504 is performed prior to act 502.

Acts 510, 512, 514, 516, and 518 may be included in act 310. In act 510, if applicable, all or part of the authentication request ([A+C]Kᵥ) may be cached or otherwise maintained for a period time. In act 512, a temporary key (e.g., a symmetric key) Kₛ is created. In act 514, an authentication response (R) is generated and encrypted using temporary key Ks. In act 516, temporary key Kₛ is itself encrypted using a public key Kₚ. In act 518, the encrypted authentication 11 response [R]Kₛ and encrypted temporary key [Kₛ]Kₚ are provided to second logic 218.

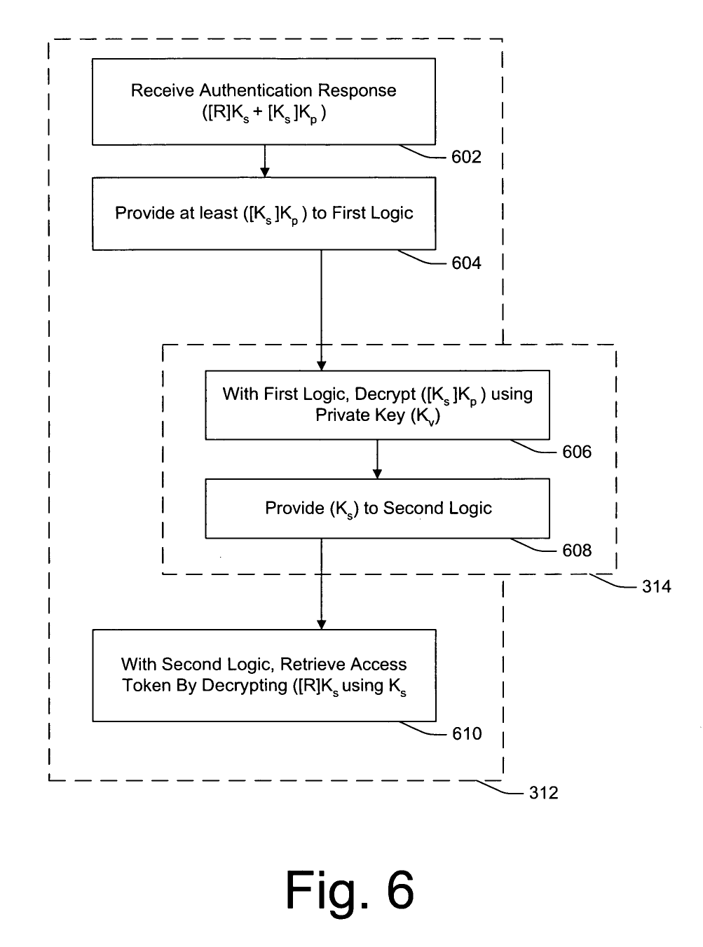

FIG. 6 is still another flow diagram depicting certain further exemplary acts associated with acts 312 and 314 of FIG. 3.

Acts 602, 604 and 610 may be included in act 312. Acts 606 and 608 may be included in act 314.

In act 602, encrypted authentication response [R]Kₛ and encrypted temporary key [Kₛ]Kₚ are received by second logic 218. In act 604, at least encrypted temporary key [Kₛ]Kₚ is provided to first logic 208. In act 606, first logic 208 decrypts encrypted temporary key [Kₛ]Kₚ using private key Kᵥ. In act 608, retrieved temporary key Ks is provided to second logic 218. In act 610, the access token or other like information in encrypted authentication response [R]Kₛ is retrieved using temporary key Kₛ from act 608.

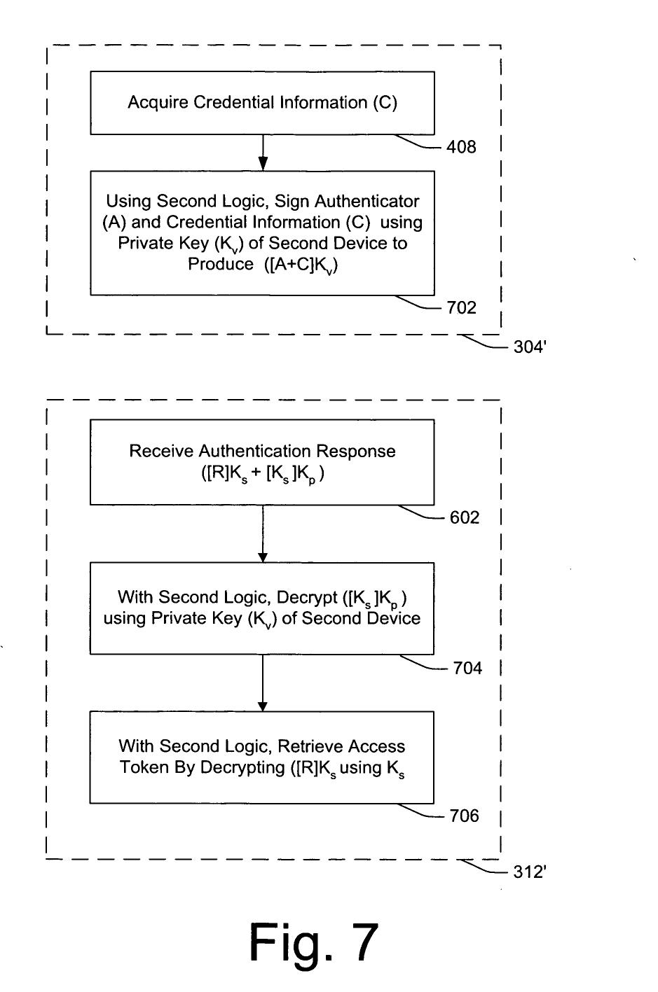

FIG. 7 is yet another flow diagram depicting certain further exemplary acts associated with alternative acts 304′ and 312′.

Here, as described in earlier examples, second logic 218 may be configured to perform certain acts is first logic 208 cannot be so configured. Thus, for example, alternative act 304′ may include acts 408 (previously described) and act 702. In act 702, second logic 218 is configured to sign the authenticator (A) and credential information (C) using private key Kᵥ associated with of second device 204 and/or second logic 218 to produce ([A+C]Kᵥ).

Alternative act 312′ may include acts 602 (previously described) and acts 704 and 706. In act 704, second logic 218 is configured to decrypt encrypted temporary key [Kₛ]Kₚ using private key Kᵥ. In act 706, with temporary key Kₛ, second logic 218 is able to retrieve the access token or other like information in encrypted authentication response [R]Kₛ using temporary key Ks from act 704.

Although some preferred embodiments of the various methods and apparatuses of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the spirit of the invention as set forth and defined by the following claims.

1. A method comprising:
establishing authentication information, said authentication information including time information associated with authenticating logic;
with first logic, establishing credential information; and
outputting an authentication request comprising said authentication information and said credential information, said authentication request being cryptographically modified.

2. The method as recited in claim 1, wherein said first logic is configured to output said authentication request.

3. The method as recited in claim 1, wherein second logic this is operatively coupled to said first logic is configured to output said authentication request.

4. The method as recited in claim 2, further comprising:
with second logic that is operatively coupled to said first logic, receiving said authentication request and outputting a selectively modified authentication request.

5. The method as recited in claim 1, further comprising:
with authenticating logic that is operatively configured to receive said authentication request, at least validating said authentication information, and authenticating said credential information.

6. The method as recited in claim 5, further comprising:
with said authenticating logic, outputting an authentication response comprising authentication approval information and corresponding cryptography information.

7. The method as recited in claim 6, further comprising:
with said first logic, accessing at least a portion of said authentication response to retrieve said corresponding cryptography information and outputting said retrieved cryptography information.

8. The method as recited in claim 7, further comprising:
with second logic that is operatively coupled to said first logic and said authentication logic, accessing at least a portion of said authentication response and using said retrieved cryptography information retrieve said authentication approval information.

9. The method as recited in claim 6, further comprising:
with said second logic, accessing at least a portion of said authentication response to retrieve said corresponding cryptography information.

10. The method as recited in claim 9, further comprising:
with said second logic, accessing at least a portion of said authentication response and using said retrieved cryptography information retrieve said authentication approval information.

11. The method as recited in claim 6, wherein said authentication request is cryptographically modified by encryption using a private key.

12. The method as recited in claim 11, wherein said private key is associated with said first logic.

13. The method as recited in claim 11, wherein said private key is associated with said second logic.

14. The method as recited in claim 11, further comprising:
with said authenticating logic, retrieving said authentication information and said credential information from said authentication request using a public key pair-wise associated with said private key.

15. The method as recited in claim 14, further comprising:
with said authenticating logic:
establishing a temporary key;
encrypting said temporary key using said public key to form said corresponding cryptography information; and
encrypting said authentication approval information using said temporary key.

16. The method as recited in claim 15, further comprising:
with said second logic, providing said encrypted temporary key to said first logic; and
with said first logic, retrieving said temporary key from said encrypted temporary key using said private key.

17. The method as recited in claim 16, further comprising:
with said first logic, providing said retrieved temporary key to said second logic; and
with said second logic, retrieving said authentication approval information using said retrieved temporary key.

18. The method as recited in claim 15, wherein said temporary key includes a symmetric key.

19. The method as recited in claim 8, wherein said first logic is substantially provided in a first device that includes a credential gathering mechanism configurable to establish said credential information, said second logic is provided at least partially in a second device, and said authenticating logic is provided at least partially in a third device.

20. The method as recited in claim 19, wherein said credential gathering mechanism is configurable to establish biometric information.

21. The method as recited in claim 19, wherein said second device includes at least one computer operatively configured as a client device, and said third device includes a computer operatively configured as a server device.

22. The method as recited in claim 19, further comprising:
generating said authentication information using at least one logic selected from said second logic and said authenticating logic.

23. The method as recited in claim 19, wherein said second logic modifies said authentication request by including certificate information in a modified authentication request.

24. The method as recited in claim 23, wherein said authenticating logic is configured to validate said authentication request based at least in part on said certificate information.

25. The method as recited in claim 5, wherein said authenticating logic is configured to validate said authentication information based on at least nonce data and timestamp data within said authentication information.

26. The method as recited in claim 5, wherein said authenticating logic is configured to authenticate said credential information by logically comparing said credential information with stored credential information.

27. The method as recited in claim 8, wherein said authentication approval information includes an access token for use by said second device.

28. The method as recited in claim 1, wherein said authentication information includes nonce data and said time information includes timestamp data.

29. The method as recited in claim 1, wherein said authentication request includes at least one type of data selected from a group of data comprising identifier data, nonce data, signature data, timestamp data, and credential data.

30. A computer readable medium having computer implementable instructions for causing one or more processing units to perform acts comprising:
establishing authentication information, said authentication information including time information associated with authenticating logic;
outputting an authentication request comprising said authentication information and credential information, said authentication request being cryptographically modified.

31. The computer readable medium as recited in claim 30, wherein first logic is configured to output said authentication request.

32. The computer readable medium as recited in claim 31, wherein second logic this is operatively coupled to said first logic is configured to output said authentication request and said first logic is configured to provide said credential information.

33. The computer readable medium as recited in claim 31, having computer implementable instructions for causing one or more processing units to perform further acts comprising at least one of the following acts:
with second logic that is operatively coupled to said first logic, receiving said authentication request and outputting a selectively modified authentication request.

34. The computer readable medium as recited in claim 30, having computer implementable instructions for causing one or more processing units to perform further acts comprising at least one of the following acts:
with authenticating logic that is operatively configured to receive said authentication request, at least validating said authentication information, and authenticating said credential information.

35. The computer readable medium as recited in claim 34, having computer implementable instructions for causing one or more processing units to perform further acts comprising at least one of the following acts:
with said authenticating logic, outputting an authentication response comprising authentication approval information and corresponding cryptography information.

36. The computer readable medium as recited in claim 35, having computer implementable instructions for causing one or more processing units to perform further acts comprising at least one of the following acts:
with said first logic, accessing at least a portion of said authentication response to retrieve said corresponding cryptography information and outputting said retrieved cryptography information.

37. The computer readable medium as recited in claim 36, having computer implementable instructions for causing one or more processing units to perform further acts comprising at least one of the following acts:
with second logic that is operatively coupled to said first logic and said authentication logic, accessing at least a portion of said authentication response and using said retrieved cryptography information retrieve said authentication approval information.

38. The computer readable medium as recited in claim 35, having computer implementable instructions for causing one or more processing units to perform further acts comprising at least one of the following acts:
with said second logic, accessing at least a portion of said authentication response to retrieve said corresponding cryptography information.

39. The computer readable medium as recited in claim 38, having computer implementable instructions for causing one or more processing units to perform further acts comprising at least one of the following acts:
with said second logic, accessing at least a portion of said authentication response and using said retrieved cryptography information retrieve said authentication approval information.

40. The computer readable medium as recited in claim 35, wherein said authentication request is cryptographically modified by encryption using a private key.

41. The computer readable medium as recited in claim 40, wherein said private key is associated with said first logic.

42. The computer readable medium as recited in claim 40, wherein said private key is associated with said second logic.

43. The computer readable medium as recited in claim 40, having computer implementable instructions for causing one or more processing units to perform further acts comprising at least one of the following acts:
with said authenticating logic, retrieving said authentication information and said credential information from said authentication request using a public key pair-wise associated with said private key.

44. The computer readable medium as recited in claim 43, having computer implementable instructions for causing one or more processing units to perform further acts comprising at least one of the following acts:
with said authenticating logic:
establishing a temporary key;
encrypting said temporary key using said public key to form said corresponding cryptography information; and
encrypting said authentication approval information using said temporary key.

45. The computer readable medium as recited in claim 44, having computer implementable instructions for causing one or more processing units to perform further acts comprising at least one of the following acts:
with said second logic, providing said encrypted temporary key to said first logic; and
with said first logic, retrieving said temporary key from said encrypted temporary key using said private key.

46. The computer readable medium as recited in claim 45, having computer implementable instructions for causing one or more processing units to perform further acts comprising at least one of the following acts:
with said first logic, providing said retrieved temporary key to said second logic; and
with said second logic, retrieving said authentication approval information using said retrieved temporary key.

47. The computer readable medium as recited in claim 44, wherein said temporary key includes a symmetric key.

48. The computer readable medium as recited in claim 37, wherein said first logic is substantially provided in a first device that includes a credential gathering mechanism configurable to establish said credential information, said second logic is provided at least partially in a second device, and said authenticating logic is provided at least partially in a third device.

49. The computer readable medium as recited in claim 48, wherein said credential gathering mechanism is configurable to establish biometric information.

50. The computer readable medium as recited in claim 48, wherein said second device includes at least one computer operatively configured as a client device, and said third device includes a computer operatively configured as a server device.

51. The computer readable medium as recited in claim 48, having computer implementable instructions for causing one or more processing units to perform further acts comprising at least one of the following acts:
generating said authentication information using at least one logic selected from said second logic and said authenticating logic.

52. The computer readable medium as recited in claim 48, wherein said second logic modifies said authentication request by including certificate information in a modified authentication request.

53. The computer readable medium as recited in claim 52, wherein said authenticating logic is configured to validate said authentication request based at least in part on said certificate information.

54. The computer readable medium as recited in claim 34, wherein said authenticating logic is configured to validate said authentication information based on at least nonce data and timestamp data within said authentication information.

55. The computer readable medium as recited in claim 34, wherein said authenticating logic is configured to authenticate said credential information by logically comparing said credential information with stored credential information.

56. The computer readable medium as recited in claim 37, wherein said authentication approval information includes an access token for use by said second device.

57. The computer readable medium as recited in claim 30, wherein said authentication information includes nonce data and said time information includes timestamp data.

58. The computer readable medium as recited in claim 30, wherein said authentication request includes at least one type of data selected from a group of data comprising identifier data, nonce data, signature data, timestamp data, and credential data.

59. A system comprising:
an authentication device having authentication logic;
a first device having first logic;
a second having second logic that is operatively coupled to said authentication logic and said first logic; and
wherein:
at least one of said authenticating logic and said second logic is configured to provide authentication information to said first logic, said authentication information including time information associated with said authenticating logic;
said first logic is configured to establish credential information,
at least one logic selected from said first logic and second logic is configured to output an authentication request comprising said authentication information and said credential information, said authentication request being cryptographically modified;
said second logic is configured to output said authentication request; and
said authenticating logic is configured to receive said authentication request, and at least validate said authentication information, and authenticate said credential information.

60. The system as recited in claim 59, wherein:
said authenticating logic is further configured to output an authentication response comprising authentication approval information and corresponding cryptography information.

61. The system as recited in claim 60, wherein said authentication approval information includes an access token for use by said second device.

62. The system as recited in claim 60, wherein:
said first logic is further configured to access at least a portion of said authentication response to retrieve said corresponding cryptography information and output said retrieved cryptography information; and
said second logic is further configured to access at least a portion of said authentication response and use said retrieved cryptography information output by said first logic to retrieve said authentication approval information.

63. The system as recited in claim 62, wherein;
said first logic is further configured to cryptographically modify said authentication request by encryption using a private key; and
said authenticating logic is further configured to retrieve said authentication information and said credential information from said authentication request using a public key pair-wise associated with said private key.

64. The system as recited in claim 63, wherein:
said authenticating logic is further configured to establish a temporary key, encrypt said temporary key using said public key to form said corresponding cryptography information, and encrypt said authentication approval information using said temporary key;
said second logic is further configured to provide said encrypted temporary key to said first logic;
said first logic is further configured to retrieve said temporary key from said encrypted temporary key using said private key, and provide said retrieved temporary key to said second logic; and
said second logic is further configured to retrieve said authentication approval information using said retrieved temporary key.

65. The system as recited in claim 60, wherein:
said second logic is further configured to access at least a portion of said authentication response to retrieve said corresponding cryptography information and use said retrieved cryptography information to retrieve said authentication approval information.

66. An apparatus comprising:
a credential gathering mechanism configurable to establish credential information;
first logic operatively coupled to said credential gathering mechanism and configured to access authentication information, said authentication information including time information associated with externally operating authenticating logic, and output an authentication request comprising said authentication information and said credential information, said authentication request being cryptographically modified.

67. The apparatus as recited in claim 66, wherein said credential information includes biometric credential information.

68. An apparatus comprising:
means for identifying authentication information that includes time information associated with authenticating logic;
means for establishing credential information;
means for outputting an authentication request comprising said authentication information and said credential information, said authentication request being cryptographically modified;
means for receiving said authentication request;
means for validating said authentication request;
means for validating said authentication information; and
means for authenticating said credential information.
